(19) United States
(12) Patent Application Publication
(10) Pub. No.: US 2021/0278378 A1
(43) Pub. Date: Sep. 9, 2021

(54) METHOD FOR COMPOUND DETECTION AND MITIGATION IN AN AQUACULTURE SYSTEM

(71) Applicant: ATLANTIC SAPPHIRE IP, LLC, Miami, FL (US)

(72) Inventor: THUE HOLM, Vejle (DK)

(21) Appl. No.: 16/991,162

(22) Filed: Aug. 12, 2020

Related U.S. Application Data
(60) Provisional application No. 62/985,592, filed on Mar. 5, 2020.

(51) Int. Cl. G01N 30/72; A01K 61/10; G01N 1/38; G01N 30/86

(52) U.S. Cl. CPC G01N 30/7206; A01K 61/10; G01N 2030/025; G01N 30/8665; G01N 1/38

(57) ABSTRACT

A method for detecting and mitigating compounds in an aquaculture system. The method for detecting and mitigating off-flavorings includes, taking at least one sample of water from at least one portion of a prospective aquaculture system that contains aquaculture, testing the at least one sample to determine at least one concentration of at least one off-flavor compound therein, and utilizing the data obtained from testing so as to regulate at least one content contained within the aquaculture system.

### BACKGROUND OF THE INVENTION

### Claim of Priority

The present application claims priority under 35 U.S.C. Section 119 to a currently pending, U.S. Provisional application having Ser. No. 62/985,592 and filed on Mar. 5, 2020 which is incorporated by reference herein in its entirety.

### Field of the Invention

The present invention relates generally to utilizing an aquaculture system, or more specifically, a recirculating aquaculture system (RAS) for aquaculture farming and more specifically, the present invention relates to a method for detecting and mitigating compounds, described as “off-flavorings” or “off-flavors,” which naturally accumulate in an RAS. Further, the present invention relates to detecting and mitigating these compounds to ensure a desired flavor profile of aquaculture produced by an RAS.

### DESCRIPTION OF THE RELATED ART

At the present day, a recirculating aquaculture system (RAS) is commonly used in the aquaculture farming industry. Essentially, an RAS provides an aquaculture farming production a means for a financially favorable production method, at least through limiting water consumption for use in farming. RAS's have proven to be highly effective in the art of aquaculture farming and are being adopted all over the world. Although RAS's are generally well received by the industry, when used, issues in aquaculture developing non-desired flavor profiles and RAS's experiencing unfavorable conditions are becoming more prevalent in conjunction with RAS farming. These issues are believed to be caused at least by the naturally occurring compound, Geosmin, which is an organic compound known to make water smell and taste foul to the average person. And, these issues are also somewhat believed to be caused at least by the naturally occurring compound, 2-Methylisoborneol (MIB), which is an organic chemical also known to make water smell and taste foul to the average person. Evidence for these beliefs are at least found in tasting samples of non-desirably flavored aquacultures produced in an RAS, wherein the samples of the aquacultures have been found to contain chemical concentrations of the compounds, Geosmin and 2-Methylisoborneol. Thus, it becomes apparent that these issues are becoming more prevalent in RAS's and plausibly, are known to be caused by both Geosmin and MIB. Subsequently, the two compounds have been known to be called “off-flavors” or “off-flavorings” or singularly, an “off-flavor.” In some cases, an off-flavor may also be an organic bromo-compound.

Currently, the best solution of mitigating the effects of aquaculture developing non-desired flavor profiles due to Geosmin and/or MIB, is to apply a process of depuration to the aquaculture. When aquaculture is tested and proven to have at least characteristics of “off-flavoring contamination,” depuration is carried out by purging the aquaculture in taint free water for up to 2 weeks before harvesting the aquaculture. This purging commonly requires large quantities of aquaculture to be transferred from one holding tank in an RAS to another holding tank, outside of the RAS. In some cases, purging may require holding tanks to be built once aquaculture is tested and proved to have at least characteristics of “off-flavoring contamination.” Subsequently, this process of depuration is financially taxing on aquaculture farms as the process causes the farming operation to operate outside of scheduled production via transferring and holding fish outside of their prospective RAS's and/or building costly holding tanks designed for depuration. Although this process is a partial solution, this process also creates a need to consume large quantities of clean water, which can be costly, and the aquaculture lose weight, potentially perish, or other negative side effects that would otherwise detract from the profitability of the aquaculture. Further, the process does not subsequently solve the issue of aquaculture attaining a non-desired flavor profile in farming cycles after depuration associated with the RAS, causing each following farming cycle to become contaminated and depuration still needing to be applied to the new cycles unless all contaminant are flushed from the RAS and replaced, generally by virtue of extensive deep cleaning, or replacing entire portions of the RAS, further adding to the cost. Another partial solution is deemed “Ozone Oxidation by Products,” which attempts to mitigate off-flavoring buildup/productions, but also has disparities similar to as discussed above. As such, there is a need for a method to detect and mitigate these compounds/off-flavors before they begin affecting aquaculture in an RAS and thereby create the need for the aquaculture to go through the process of depuration and/or have the process of ozone oxidation by products applied thereto and also, if the depuration process must be carried out, a need arises for a method to ensure these compounds/off-flavors will not affect aquaculture in an RAS per new farming cycles.

### SUMMARY OF THE INVENTION

In view of the foregoing disadvantages inherent in recirculating aquaculture systems now present today, the present invention provides a new method for compound detection and mitigation in an aquaculture system.

The general purpose of the present invention, which will be described subsequently in greater detail, is to provide a new method for compound detection and mitigation in an aquaculture system of which many novel features are a result, which are not anticipated, rendered obvious, suggested, or even implied by any of the prior art of aquaculture systems either in combination or singularity thereof.

Thus, the present invention is directed to a method to detect and/or mitigate at least one compound found in an aquaculture system, and more specifically, a recirculating aquaculture system (RAS). This method may also be known as preserving optimal flavoring of fish bred in an aquaculture system. The method may include, but not be limited to, taking at least one sample of water from at least one portion of the aquaculture system that contains the fish, testing the at least one sample of water to determine at least one concentration of at least one off-flavor compound therein, comparing the concentration of said off-flavor compound to an optimal concentration range, regulating the water in the aquaculture system to maintain a concentration of said off-flavor compound in the water within the optimal concentration range, and maintaining the fish within the regulated water for at least a predetermined period of time so as to reduce an amount of off-flavor that may be present in the fish.

As previously described, the aquaculture system having the method applied thereto may be a recirculating aquaculture system. The RAS may contain at least one interworking of which could be, but not be limited to, fish tanks, temperature sensors, oxygen sensors, mechanical filters, discharge pumps, backwash pumps, level sensors, reservoirs, pH sensors, pumps, lime dosing units, pumps, biological filters, trickle filters, oxygen cones, UV filters, wastewater injection systems, sludge tanks, flocculation tanks, drill strings, hatcheries, pump sumps, denitrification filters, fries and pans, sludge concentration filters, smolt tanks, post smolt tanks, and/or on growing tanks.

As the RAS may comprise a plurality of tanks, the step of regulating the water in the aquaculture system could further comprise regulating the water within at least one tank, wherein the tank can be a tank where the fish originally resided prior to testing, or a tank alternate from where the fish originally resided prior to testing. The fish may then maintain their original location, within the now regulated tank for a period of time. In an alternative embodiment, the fish may be transferred to a regulated tank, different from where the fish originally resided and maintain their position in the regulated tank for a predetermined period of time. Further, when at least one sample of water is taken, a plurality of samples of water may also be taken from different tanks within the system and then the samples may be tested to be able to compare samples from all the tanks so as to identify variations of concentrations in the tanks. Further yet, samples of water may be taken from a plurality of different portions of the aquaculture system that contain fish at varying stages of development.

The at least one compound that the at least one sample of water may be tested for may be compounds such as, but not limited to Geosmin or 2-Methylisoborneol (MIB). These compounds may further be known as “off-flavors,” “off-flavorings,” or a single “off-flavor.” These compounds may also be known to produce non-desired flavor profiles of aquaculture, at least when the aquaculture is exposed, by means of contact, breathing, or otherwise, to the compounds, rather in singularity of just one of the compounds, or both. The concentration range that produces a non-desired flavor profile in the aquaculture may be a concentration of above 5 nanograms of Geosmin per liter of water and above 15 nanograms of MIB per liter of water when the fish are exposed to the compounds in water. A location of the RAS that contains concentrations below this range may be described as a safe limit location.

When the at least one sample of matter is tested for a concentration level (which may also be known as concentration limits) of least one compound, testing can take place via multiple different means. Testing may be carried out on a sample of matter, but not be limited to, stir bar sorptive extraction, gas chromatography-mass spectrometry, Spearman's correlation analysis of data, ANOVA analysis of data, and any combination or singularity thereof.

As water may be regulated in a tank of the RAS, and subsequently, fish maintained in the tank for a predetermined period of time of at least one week, further steps may be taken within or after the predetermined period of time. These steps may be, but not be limited to, periodically sampling a fish from within the regulated water, determining concentrations of said off-flavor compound in the sampled fish, and maintaining the fish within the regulated water until the sampled fish has concentrations of the off-flavor compounds below less than 200 nanograms of Geosmin per kilogram of fish tissue and less than 500 nanograms of MIB per kilogram of fish tissue.

Regardless of if the fish were transferred to an alternate tank, or resided in the tank they originally would have resided in prior to testing, the methodology calls to ensure the fish become located and are maintained in a safe limit location (that may contain regulated water) for at least a predetermined period of time so as to obtain and/or preserve optimal flavoring.

The maintaining of the fish in a safe limit location for at least a predetermined period of time so as to obtain and/or preserve optimal flavoring may then be followed by targeting associated compound producing sources. Targeting may be defined as identifying compound producing sources, which are generally at least one interworking of a prospective RAS. The act of targeting may also be facilitated by virtue of matching. Wherein, upon a sample being taken and subsequently tested, once the test has yielded concentration limit results, the sample and the results can then be matched back to the location it was taken at, and a user may then gain more insight as to what may be producing, if any, off-flavors. Upon this targeting and subsequently matching process, a remedying of the targeted compound producing sources from producing at least one compound may be completed. Such a targeted source(s) may be any interworking of the RAS, or, more specifically, an interworking of the RAS that has come in contact with a byproduct of the RAS, such as, but not limited to, fish waste, fish feed or sludge. This remedying may comprise avoiding or limiting clearing/cleaning of an interworking of the RAS, improving rates at which resources get added to the RAS, such as a nitrification rate, and/or adjusting the frequency of cleaning and/or backwashing an interworking of the RAS and more, again, as will be subsequently described.

The method may also include, but not be limited to, taking at least one sample of matter from at least a portion of an RAS, then testing the at least one sample of matter to determine a concentration of at least one compound in such an at least one sample of matter, and then, regulating the RAS accordingly upon determining a concentration of the at least one compound in the at least one sample of matter. In another embodiment, this may be described as, taking at least one sample of water from at least one portion of the aquaculture system that contains fish, testing the at least one sample of water to determine at least one concentration of at least one off-flavor compound therein, and regulating at least one content of the aquaculture system accordingly upon determining a concentration of the at least one sample of water. The at least one sample of matter may be, but not be limited to, matter that maintains an unfixed volume and shape, such as, but not limited to, water, aquaculture tissue, sludge, or combinations thereof.

The at least one portion of the RAS that has at least one sample of matter taken from it, may be an inlet into the RAS, an interworking of the RAS, an outlet of the RAS, or any combination or singularity of these elements. An inlet of an RAS may be defined as, any area in which the RAS receives a resource that the system will use in order to operate such as, water or aquaculture feed. An outlet may be defined as, any area in which the RAS discharges or otherwise gets rid of an unused or used resource such as, fish waste, sludge, or water. An interworking of the RAS could be any singular or combination of the elements as previously described.

As there are many possible locations for a sample of matter to be taken from a prospective RAS, at least one sample is taken. In some embodiments of the present invention, multiple samples can be taken. Multiple samples can be taken from one portion of the RAS and/or multiple samples can be taken across multiple portions of the RAS. Multiple samples may also be composed of multiple types of matter wherein the matter maintains an unfixed volume and shape. By way of non-limiting example, if two samples were taken, one sample could be a sample of matter wherein the matter is aquaculture tissue and the other sample could be water. There also may be an unlimited timeline in which samples take place. By way of non-limited example, again, if two samples were taken, one sample could be on a “day 1,” and another could be on a “day 5.”

As should be inherent, the RAS may be structured to contain, grow, and/or otherwise farm aquaculture. The aquaculture may be, but not be limited to, shrimp, lobster, scallops, salmon, tuna, sea bass, halibut, cod, jack, octopus, anchovies, crab, marlin, swordfish, mahi mahi, porgy, snapper, hog fish, ballyhoo, catfish, trout, eel, flounder, herring, tilapia, sturgeon, pikeperch, whitefish, carp, haddock, mullet, and/or mackerel.

As previously stated, the at least one compound that the at least one sample of matter may be tested for may be compounds such as, but not limited to Geosmin or 2-Methylisoborneol (MIB).

Also as previously described, when the at least one sample of matter is tested for a concentration level (which may also be known as concentration limits) of least one compound, testing can take place via multiple different means. Testing may be carried out on a sample of matter, but not be limited to, stir bar sorptive extraction, gas chromatography-mass spectrometry, Spearman's correlation analysis of data, ANOVA analysis of data, and any combination or singularity thereof.

Upon determining a concentration of at least one compound, a prospective RAS, and subsequently at least one of its contents (which may be, but not be limited to aquaculture, water, sludge or any byproduct of the aquaculture system or resource that enters the aquaculture system) may then be regulated accordingly in relation to the concentration and/or concentration level/limit the testing has yielded. Regulating an RAS accordingly may be carried out by virtue of designating aquaculture within the RAS to an appropriate area. An appropriate area may be, a portion of the RAS the aquaculture would be placed in as if the system were to continue functioning as normal, a location within the RAS but alternate to where the aquaculture was previously located within the RAS, or an isolated depuration tank. An appropriate area may also be defined as a safe limit location, or a non-safe limit location, which may be described as, but not be limited to, a warning limit or a critical limit.

The designation of aquaculture may be dependent on the concentration determined by testing. A concentration may be designated between concentration levels or limits, the first level may be thought of as a safe limit, the next level may be thought of as a warning limit, and the third level may be thought of as a critical level. A safe limit may be defined as a concentration of at least one off-flavor that will not noticeably affect the flavor profile of the aquaculture. A warning limit may also be defined as a concentration of at least one off-flavor that will not noticeably affect the flavor profile of the aquaculture, but may be nearing a quantifiable concentration value of an off-flavor that may noticeably affect the flavor profile of the aquaculture. Lastly, a critical level may be defined as a concentration of at least one off-flavor that will noticeably affect the flavor profile of the aquaculture.

In an embodiment wherein aquaculture is designated to a portion of the RAS the aquaculture would normally be placed without intervention, the RAS may then be subjected to continue functioning as normal without interruption, as will be subsequently described. This embodiment is generally followed after the testing yields results that defines aquaculture to retain their prospective desired flavor profiles, generally by virtue of the concentration testing has yielded to be designated as a safe limit. After a period of time, the entire method could then be designated as complete or be restarted.

In another embodiment, the aquaculture may be taken from a first location and placed in an alternate portion of a prospective RAS. This alternate portion of the RAS may be deemed to be a safe limit location. This safe limit location may be defined as, a portion of the prospective RAS that has at least one safe limit of a concentration of at least one off-flavor. This placement may occur following when a concentration of at least one of the off-flavors has been tested at a first location a of the RAS and has been determined to be at a warning limit or critical limit. Following this testing and determination, is when aquaculture may be taken and placed to an alternate, safe limit location portion of the RAS.

In yet another embodiment, the aquaculture may remain in a first location following testing, even in the event that testing yielded a critical limit location. In such an embodiment, the water at the critical limit location may be regulated so as to bring in non-off-flavor contaminated water into the location and dilute the critical limit location. In this embodiment, the location may then be subsequently become a safe limit location.

This placement of aquaculture in an alternate portion of a prospective RAS or keeping of aquaculture in a first location may then be followed by targeting associated compound producing sources. Targeting may be defined as identifying compound producing sources, which are generally an interworking(s) of a prospective RAS. The act of targeting may also be facilitated by virtue of matching. Wherein, upon a sample being taken and subsequently tested, once the test has yielded at least one concentration limit, the sample and the results can then be matched back to the location it was taken at, and a user may then gain more insight as to what may be producing, if any, off-flavors. Upon this targeting and subsequently matching process, a remedying of the targeted compound producing sources from producing at least one compound may be completed. Such a targeted source(s) may be any interworking of the RAS, or, more specifically, an interworking of the RAS that has come in contact with a byproduct of the RAS, such as, but not limited to, aquaculture waste, aquaculture feed or sludge. This remedying may comprise avoiding or limiting clearing/cleaning of an interworking of the RAS, improving rates at which resources get added to the RAS, such as a nitrification rate, and/or adjusting the frequency of cleaning and/or backwashing an interworking of the RAS and more, as will be subsequently described.

In yet another embodiment, the aquaculture may be isolated via placement of the aquaculture in a depuration tank and/or putting the aquaculture through the process of depuration. Such a placement may be elicited by aquaculture existing in a first location, then that first location being sampled, tested and determined to have a critical level of a concentration of at least one off-flavor. Upon placement of the aquaculture in a depuration tank, the aquaculture is designated to remain there for a pre-determined period of time. The depuration tank may contain taint free water. Further, as the aquaculture may be designated to remain in the depuration tank for a pre-determined period of time, the depuration tank may be subject to pre-determined refreshing and/or cycling of taint free water throughout the course of aquaculture being designated to remain in the depuration tank for a pre-determined period of time. The aquaculture, after remaining in the tank for the predetermined period of time may then be sampled, by means of tasting, or by testing the chemical residue associated with the aquaculture's prospective tissue. The flavor profile may then be ensured.

This placement of aquaculture in a depuration tank and/or putting the aquaculture through the process of depuration may then be followed by targeting associated compound producing sources. Targeting may be defined as identifying compound producing sources, which are generally at least one interworking of a prospective RAS. The act of targeting may also be facilitated by virtue of matching. Wherein, upon a sample being taken and subsequently tested, once the test has yielded concentration limit results, the sample and the results can then be matched back to the location it was taken at, and a user may then gain more insight as to what may be producing, if any, off-flavors. Upon this targeting and subsequently matching process, a remedying of the targeted compound producing sources from producing at least one compound may be completed. Such a targeted source(s) may be any interworking of the RAS, or, more specifically, an interworking of the RAS that has come in contact with a byproduct of the RAS, such as, but not limited to, aquaculture waste, aquaculture feed or sludge. This remedying may comprise avoiding or limiting clearing/cleaning of an interworking of the RAS, improving rates at which resources get added to the RAS, such as a nitrification rate, and/or adjusting the frequency of cleaning and/or backwashing an interworking of the RAS and more, again, as will be subsequently described.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a flowchart illustrating the overall process of the present invention of a method for compound detection and mitigation in a recirculating aquaculture system.

FIG. 2 is a flowchart illustrating a more detailed process of the present invention as show in FIG. 1.

FIG. 3 is yet another flowchart illustrating a more detailed process of the present invention as shown in FIG. 1.

FIG. 4 is yet another flowchart illustrating a more detailed process of the present invention as show in FIG. 1.

Like reference numerals refer to like processes throughout the several views of the drawings.

### DETAILED DESCRIPTION OF THE PREFERRED EMBODIMENT

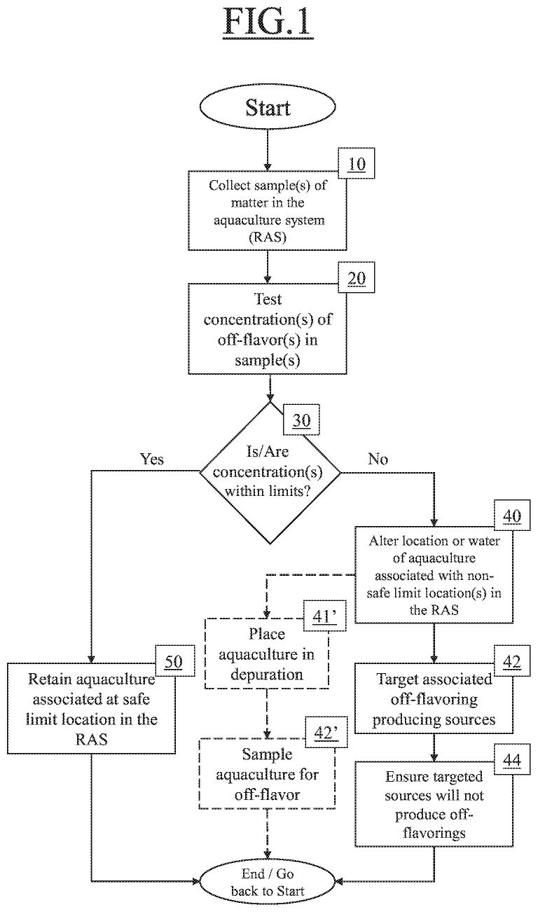

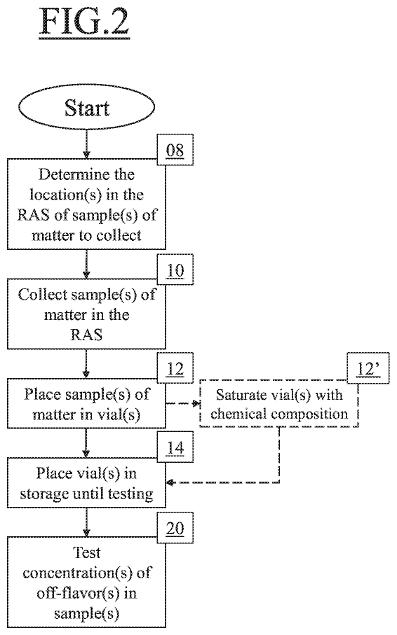

Turning now descriptively to the figures, FIG. 1 illustrates an inventive method for compound detection and mitigation in an aquaculture system from the standpoint of a general overview. The aquaculture system can be, and will be referred to as a recirculating aquaculture system. FIGS. 2-4 will be subsequently described, and rely on FIG. 1 for context as they are more detailed and magnified processes of the present invention described in FIG. 1.

FIGS. 1 and 2 may be described as a starting point for the present inventive method and includes the location or locations within a recirculating aquaculture system (RAS) of a sample or samples of matter to collect 08. It may be important to note, the ambient air around an RAS or around a facility in which an RAS may be defined as a location or multiple locations as identified in procedure 08. A user, group, team, automated computer system, robot, or otherwise will complete this procedure, and subsequently most others, and will be referred to as “a user” or “the user” or “user.” A user may choose a single location or multiple locations of a recirculating aquaculture system to carry out procedure 08. Once the procedure of determining the location or locations within an RAS of a sample or samples of matter to collect 08 has been completed, the user may choose to indicate and/or record which location or locations of the respective RAS has been selected. Indication and/or recording of which location or locations of the RAS has been selected may be recorded by pen and paper, computer table entry, and/or by automated means.

Following completion of procedure 08, the user may then collect a sample or samples of matter held within the RAS 10. 10's collection of a sample or samples may be made in regards to the location or locations determined in 08. Procedure 10 may be carried out by collecting one sample of matter or multiple, wherein the user may then indicate properties of the sample or samples of matter, such as, but not be limited to, the time and date in which the sample or samples was/were taken, what the contents of the sample or samples is/are, mass or masses of the sample or samples, and/or other basic quantifiable properties of the sample or samples. The sample or samples may also be taken at a location or locations designated to different stages of aquaculture development, which, by non-limiting example, may have a sample taken at a portion of the aquaculture system designated to hold aquaculture at 1 week since birth, and another sample is taken at a portion of the aquaculture system designated to hold aquaculture at 3 weeks since birth. By way of further example, a sample or samples of ambient air around the RAS and/or around the facilities in which the RAS is housed may be taken by means of collecting air through a gas washing flask(s) using a vacuum pump and/or exposing absorbent tubes and/or traps, such as Tenax traps to such ambient air. By way of another non-limiting example, if multiple samples are taken, a user may choose to take an individual sample, or multiple samples at one point in time, and then may choose to take an individual sample, or multiple samples at another point in time.

Upon completion of procedure 10, the user may then place the sample or samples of matter in a vial or vials 12. This placing of the sample or samples of matter in a vial or vials may also be accompanied with the procedure of saturating the vial or vials with a chemical composition 12′. The vial or vials as described in procedure 12 may be composed of glass, aluminum, plastic, or any other material generally comprising vials, or any combination or singularity thereof. In one embodiment, the vial or vials may be known as a flask or flasks. In such an embodiment wherein the vial or vials are known as a flask or flasks, the flask or flasks may contain samples of a specified volume of ambient air. In an embodiment wherein the vial or vials as described in procedure 12 is/are composed of plastic, such plastics should be free from any flavor compounds and certified for collecting water samples for chemical analysis, such as, but not limited to Nalgene Bottles, fluorinated polypropylene bottles, and/or Teflon bottles. The vial or vials may also be open topped, wherein the contents of the vial are at least partially exposed to the prospective environment, or the vial or vials may be closed top, wherein the contents of the vial are sealed and unexposed to the prospective environment. The chemical composition, as described in procedure 12′ may be that of sodium chloride or any other chemical composition known for saturation at any given concentration level, from 0-99.99 percent.

After a user completes procedure 12, and possibly 12′, the user may then place the vial or vials in storage until testing 14. The procedure 14, may allow the vial or vials to be placed in a temperature controlled storage area, or a lab or environment associated with the user's testing area. If the vial or vials are to be placed in a temperature controlled storage area, the temperature may be set at a level so as to not alter the material properties of the sample or samples in the vial or vials. In an embodiment wherein the vial or vials as described in procedure 12 is/are composed of glass, a user may then place the vial or vials in storage in a temperature controlled storage area for a predetermined period of time at a temperature such as 41 degrees Fahrenheit. In an embodiment wherein the vial or vials as described in procedure 12 and above is/are composed of plastic, a user may then place the vial or vials in a storage temperature controlled storage are for a predetermined period of time at a temperature such as negative 4 degrees Fahrenheit.

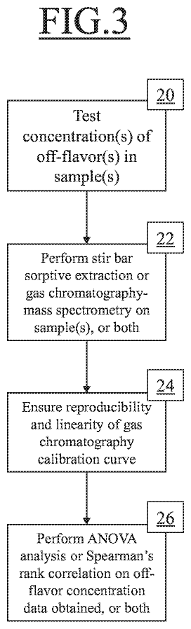

Referring now to FIGS. 1 and 3, the procedures described within FIG. 3 will be completed following the procedures as shown and described in FIG. 2. and parts of FIG. 1. A user may take the vial or vials that were placed in storage until testing, as described in procedure 14, and prepare them for testing. Preparing the vial or vials for testing may include moving the vials from storage to a prospective testing area. A user may then test for a concentration or concentrations of a compound or compounds within the sample or samples 20. In procedure 20, one example of the compounds that may be tested for may better be known as Geosmin or 2-Methlyborneol (MIB). These two naturally occurring compounds may also be referred to as “off-flavorings,” “off-flavors,” or in singularity as an “off-flavor.” Testing may also be performed so as to identify organic bromo-compounds.

The testing, as described in procedure 20 may be carried out via the methods of stir bar sorptive extraction and/or gas chromatography-mass spectrometry on the sample, or samples 22. By way of non-limiting example, the method of stir bar sorptive extraction in procedure 22 may be carried out by utilizing at least one commercial stir bar, which may be coated with polydimethylsiloxane. The stir bar or stir bars may then be placed in the vial or vials which result from procedure 12 and/or procedure 12′ wherein the vial or vials contain at least one sample. The stir bar or stir bars may then be stirred at a set revolution per minute for a specified period of time with the vial or vials. The stir bar or stir bars may then be removed via utilization of forceps, rinsed in diluted water, and dried with lint-free tissue. After drying, the stir bar or stir bars may then be transferred to thermal desorption tubes for further analysis.

By way of non-limiting example, the method of gas chromatography-mass spectrometry may then be carried out on the sample or samples following the example of stir bar sorptive extraction as described previously. This example, may take the stir bar or stir bars that had been transferred to thermal desorption tubes and a user may prepare a calibration curve or multiple calibration curves about a stir bar or stir bars from a gas chromatography mixture of Geosmin and MIB pure compounds at a multitude of dilution series, in ng/L in water. An automated thermal desorption unit may then be used to analyze the thermal desorption tubes in relation to the prepared calibration curve or calibration curves. Throughout the process of gas chromatography-mass spectrometry, a dilution or dilutions for a standard curve or curves may be analyzed in singular, duplicate, or triplicates. The standard curve or curves may also be prepared separately for each sample and/or sample type if in the process there are multiple samples and/or sample types. In the embodiment as previously described wherein ambient air was sampled, such a sample or samples may be subject also to stir bar sorptive extraction, automated thermal desorption, gas chronometry mass spectrometry, and/or a combination thereof.

Upon completion of procedure 22, a user may ensure reproducibility and linearity of the gas chromatography calibration curve or curves 24. This may be completed, by way of non-limiting example via continuing the non-limiting example as described above, of gas chromatography-mass spectrometry. A user, may analyze the calibration curve or curves that resulted from gas chromatography-mass spectrometry from a statistical standpoint. A user may quantify the data from such a calibration curve or curves and place the data in a statistical software, such as JMP. A user may also quantify alternative data that resulted from previous procedures in the method at the user's discretion to be used in conjunction with data accumulated from gas chromatography-mass spectrometry and place the data in a statistical software, such as JMP. The data may then be analyzed via assistance of statistical software such as JMP, to obtain values such as, but not be limited to, relative standard deviations or R-squared values. Upon analyzation, a user should ensure reproducibility and linearity of data to be satisfactory via obtaining relative standard deviation values of less than 3 percent and R-squared values equal to or greater than 0.98.

Following procedure 24, a user may then perform ANOVA analysis and/or a Spearman's rank correlation on the off-flavor or off-flavors concentration data obtained 26. By way of non-limiting examples via continuing the non-limiting example as described above, that of procedure 24. Following ensuring reproducibility and linearity, a user may wish to then test the data obtained from gas chromatography-mass spectrometry or data the user quantified to be used in conjunction with gas chromatograph-mass spectrometry to obtain further quantifiable data. Further quantifiable data may be obtained by running tests in a statistics software such as JMP on data entered in the software and performing an ANOVA analysis and/or a Spearman's rank correlation. A user may then analyze the ANOVA results to ensure a p-value of less than 0.01 or 0.05, which may vary accordingly to one skilled in the art of statistics, dependent on sample size. A user may then analyze a Spearman's rank correlation to obtain pre-specified r-values, related to the sample or samples.

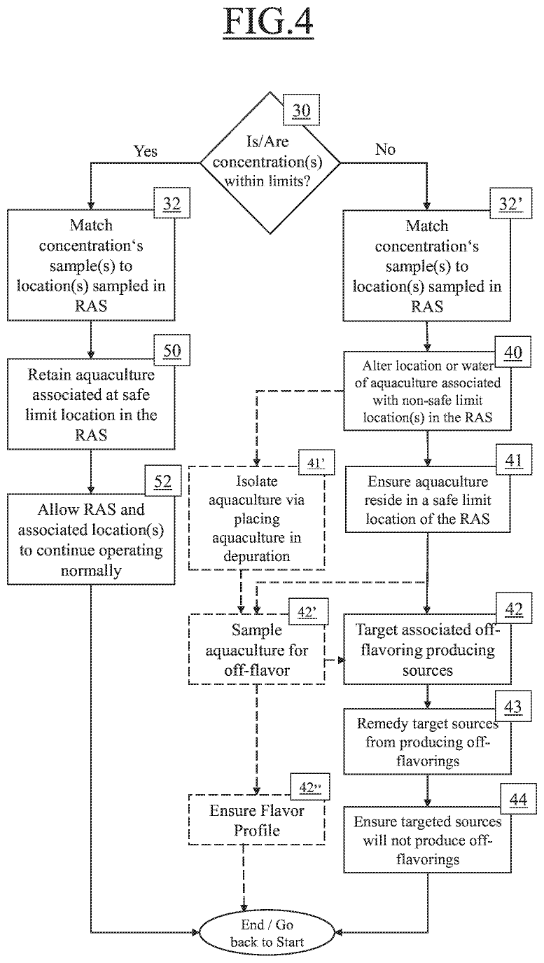

Referring now to FIGS. 1 and 4, following the process of testing a concentration level or levels of an off-flavor or off-flavors in either one or multiple samples 20, a user may then determine if the tested concentrations are within limits 30. Limits may be defined as a concentration level or concentration levels of at least one compound that specify a limit or limits in which a prospective RAS may operate at, to not have its aquaculture seriously affected by the prospective at least one compound. These limits, which may also be referred to as levels, may be thought of in three types. The first may be thought of as a safe limit, the next level may be thought of as a warning limit, and the third level may be thought of as a critical level. A safe limit may be defined as a concentration of at least one off-flavor that will not noticeably affect the flavor profile of the aquaculture. A warning limit may also be defined as a concentration of at least one off-flavor that will not noticeably affect the flavor profile of the aquaculture, but may be nearing a quantifiable value that may noticeably affect the flavor profile of the aquaculture. Lastly, a critical level may be defined as a concentration of at least one off-flavor that will noticeably affect the flavor profile of the aquaculture. These limits may also be described in terms of location. By way of non-limiting example, if a portion of the RAS was tested and the test yielded a critical level of concentration, this portion may be thought of as a critical level location. The description of the limits in terms of location can be applied to all limits, safe, warning, or critical as described in the non-limiting example above.

At least one advantageous result of determining if the tested concentrations are within concentration limits 30, is to ensure the aquaculture will retain their flavor profile and ensure a prospective RAS will continue functioning as designed.

As a single, or multiple samples can comprise multiple different substances, such as, but not limited to water, aquaculture tissue, or sludge, concentration limits may be defined differently for each distinct substance. By way of non-limiting example, if water is tested, concentration limits, further defined as safe limits pertaining to the off-flavors of Geosmin and MIB may be, less than 5 nanograms of Geosmin per liter of water and/or less than 15 nanograms of MIB per liter of water. Also, by way of non-limiting example, if fish tissue is tested, concentration limits, further defined as safe limits pertaining to the off-flavors of Geosmin and MIB may be 200 nanograms of Geosmin per kilogram of fish tissue and 500 nanograms of MIB per kilogram of fish tissue.

Once a user has determined if a concentration or concentrations of a sample or samples fall within concentration limits by virtue of procedure 30, and subsequently, will have deemed a sample or samples to be at safe limits, warning limits, and/or critical limits, a user may then decide between two preferred embodiments to continue the inventive method. Both embodiments start by matching a concentration's sample to the location sampled in the RAS 32 (also 32′ per an alternative embodiment). Essentially, a user will match by virtue of identifying the location or locations where the tested sample or samples was/were taken from about the RAS. In the event that a user in procedure 30 realized that the concentration of a sample or samples was within safe limits, then a user may follow the preferred embodiment as shown in in FIG. 4 pertaining to procedure 32 and subsequently name the location the sample was sampled at as a safe limit location. In the event that a user in procedure 30 saw that the concentration of a sample or samples was not within safe limits or may have deemed the concentration was within warning limits or critical limits then a user may follow the preferred embodiment as shown in FIG. 4 pertaining to procedure 32′ and subsequently name the location the sample was sampled from as a warning limit location or critical limit location respectively. As multiple samples can be taken in earlier procedures of the inventive method, a user may carry out both embodiments simultaneously if at least one of multiple samples differs from at least one other sample in being within the described limits.

Regardless of which embodiment a user takes, or if a user decides to take both, following procedures 32 and 32′ the user will engage in designating at least one content of the aquaculture system to an appropriate area. This designation may also be known as regulating the RAS. This action of regulating may also be defined as controlling or maintaining the process of the RAS such that it operates per user inputs/desires.

Following procedure 32, a user may regulate the RAS by designating the aquaculture associated with within safe limit location(s) in the RAS 50 or designating aquaculture to remain in the RAS as the aquaculture would normally be placed without intervention. This procedure regulates the RAS by virtue of retaining the aquaculture in their prospective locations that is the location the aquaculture were in before testing, or the location the aquaculture were following testing and procedure 32. This procedure 50 may then be followed by allowing the RAS and associated locations tested to continue operating normally 52. A user allowing the RAS to continue functioning as normal may be defined as, a user carrying out the normal associated processes, methods, mitigating off-flavor buildup (as will be discussed below) or otherwise standard operating procedures of the prospective RAS, including portions of this methodology. Upon allowing the RAS to continue functioning as normal 52, the present invention may be restarted or come to an end.

Following procedure 32′, a user may regulate the RAS so as to mitigate off-flavor build up in the contents of the aquaculture system and/or preserve optimal flavor of the aquaculture farmed by the system. In one embodiment, a user may regulate the location of the aquaculture associated with a non-safe limit location 40. In another embodiment, a user may regulate the water aquaculture are in contact with at a non-safe limit location 40.

In the event that procedure 32′ was taken and aquaculture were associated with critical limit locations, the aquaculture may be subject to non-desired flavor profiles. Then, a user may decide to isolate the aquaculture to depuration 41′ by means of transporting the aquaculture from a prospective location with the RAS to an isolation tank. Transporting the aquaculture may take place, but not be limited to, netting aquaculture then releasing aquaculture in an isolation tank. An isolation tank may be filled with taint free water, and also conform to the type of water required by prospective aquaculture. This conforming of water may mean the isolation tank is filled with salt, fresh, or brackish water. The aquaculture will then remain in the isolation tank for at least a period of one day, up to three weeks. At least one advantageous result of this process is to purge aquaculture of any off-flavoring the aquaculture may have absorbed into their anatomical tissue. Subsequently, this purging may allow for the aquaculture's prospective flavor profile to return to a natural state, or state unaffected by off-flavorings.

Upon aquaculture remaining in the isolation tank for a specified period of time, a user, or group of taste-testers may then sample the prospective aquaculture for off-flavorings 42′. Such sampling may take place via compound analysis, or a group of taste testers, may consume the aquaculture such to ensure a flavor profile 42″. Upon determination and results of the sampling, the aquaculture may be left in depuration, moved to a slaughter for harvesting, or placed back in a prospective RAS. Although there is an intermediate procedure following procedure 42′ (as will be discussed below), after procedure 42″, a user may then end or restart the inventive method.

In the event that procedure 32′ was taken and aquaculture were associated with warning limit locations or critical limit locations, the aquaculture may not be at risk to be subject to non-desired flavor profiles, or be subject to non-desired flavor profiles, and a user should be aware that the warning limit could arise to a critical limit at any time. As such, a user could place aquaculture associated with a warning limit or critical limit location in a safe limit location of the RAS 41. By way of non-limiting example, this may be carried out by virtue of moving the aquaculture from one location (as will generally be associated with a warning limit location) to an alternate location of the RAS (as will generally be associated with a safe limit location). Dependent on the type of limit location the aquaculture was associated with, the aquaculture may be subject to holding in the safe limit location for a predetermined period of time.

In an alternative embodiment, and in the event that procedure 32′ was taken and aquaculture were associated with critical or warning limit locations, once again, the aquaculture may be subject to non-desired or near non-desired flavor profiles. Then, a user may decide to alter the water associated with the aquaculture at such a tested location 40. This procedure may be carried out, but not be limited to pumping in fresh, off-flavor-free water from an external source into the prospective tested location, and/or diverting water from a safe limit location of the aquaculture system to the prospective tested location. In the non-limiting example above, the outcome would be to dilute the out of concentration limit location with water that does not contain off-flavors. This would be so as to ensure subsequent steps could be carried out.

By way of non-limiting example, a combination of the two scenarios may also be performed. Aquaculture may be moved from a critical limit location or warning limit location to another critical limit location or warning limit location, that has previously had fresh, off-flavor-free water pumped in to the prospective location.

As there are generally many portions of an RAS that contain many distinct groups of aquaculture, a user may also decide a singular or groups of aquaculture located in one portion of the RAS may be moved elsewhere, wherein another singular or group of aquaculture remain in the RAS as normal, vice versa, or any combination thereof.

Regardless as to if procedure 41 or 41′ is taken, a user will then target associated off-flavoring producing sources 42. The procedure of targeting associated off-flavoring producing sources may concurrently be carried out upon a user moving the aquaculture from a first location to an alternate location of the RAS 41, such as a safe limit location and/or isolating the aquaculture to depuration 41′ by virtue of placing the aquaculture in a depuration tank, or after those procedures. Targeting associated off-flavoring producing sources may be defined as identifying compound producing sauces, which are generally interworking of an RAS. The act of targeting may also be facilitated by virtue of matching. Wherein, upon a sample being taken and subsequently tested, once the test has yielded concertation limit results, the sample and the results can then be matched back to the location it was taken at, and a user may then gain more insight as to what may be producing, if any, off-flavors. A user may gain more insight as to what may be producing off-flavors dependent on the location the sample had been matched to. By virtue of non-limiting example, if a user determined a sample to be associated with a critical limit location, and that location was an on-growing tank, a user may utilize a pre-fabricated list that indicates interworking(s) associated with that on-growing tank.

Once a user has targeted and identified what off-flavoring producing sources exist within the RAS, a user may then remedy the targeted sources from producing off-flavorings.

By way of non-limiting example, a user may remedy the targeted sources from producing off-flavorings by, draining water in tanks within the RAS and sterilizing such tanks, flushing and/or backwashing an interworking of the RAS (or limiting such an action), such as a pump, denitrification unit, biofilter, trickling filters, or drum filters and/or improving nitrification rates of the RAS to reduce ammonium levels. These acts of remedying may be correlated or directly associated with certain times and/or frequencies in which the RAS is operating. To illustrate this fact by way of non-limiting example, a user of the RAS may remedy the RAS at a specified time before or after a process of on-growing, harvesting or otherwise farming the aquaculture in the RAS.

In one embodiment, the user may have aquaculture transferred from a first tank in the RAS to a second tank in the RAS. Upon this transferring, a user may then drain the water in the first tank by virtue of syphoning off the first tank's water supply, aerating the tank with atmospheric air, and sterilize the tank by virtue of removing any residue and/or water residue, then slowly re-introducing water into the tank without the process of draining and sterilizing the first tank affecting the second.

In another embodiment, a user may limit the flushing of an interworking of the RAS and/or adjust the frequency of backwashing an interworking of the RAS. This action may be completed as it has been discovered that off-flavorings congregate or rapidly multiply on or near one or more of the above specified interworking. In this embodiment, such an action may be carried out before slaughter of aquaculture.

In yet another preferred embodiment, the user may alter the rate at which the RAS oxidizes ammonia to nitrite (nitrification rate). This action may be completed as it has been discovered that increases in off-flavorings correlate directly to ammonium levels in a prospective RAS. Thus, a user may increase or decrease nitrification rates of the RAS at certain times dependent on the farming cycle of aquaculture so as to ensure control over off-flavorings or off-flavoring production in the system.

At least one advantageous result of this is in of the targeted sources from producing off-flavorings is that upon remedying, aquaculture then placed in the RAS will be less disposed to off-flavorings, and subsequently having their prospective flavor profile compromised.

Following a user remedying the targeted sources from producing off-flavorings, a user may then ensure that the targeted sources will not produce off-flavorings again 44. This procedure will be completed as preventative maintenance. Wherein the preventative maintenance can be described as a method and/or procedure that a user of the RAS carries out on a one time, or regular basis.

By way of non-limiting example, one method by which a user may ensure that the targeted sources will not produce off-flavorings again, may follow targeting the source of biofilters and denitrification units as off-flavoring producing sources. To ensure these sources will not produce off-flavorings again, a user may avoid or limit cleaning of the biolfilters and denitrification units prior to a harvesting of the aquaculture held within a prospective RAS to prevent potential uptake of off-flavorings.

By way of another non-limiting example, one method by which a user may also ensure that the targeted sources will not produce off-flavorings again, may follow targeting the sources of an off-flavoring producing source to be an interworking of the RAS. A user may then divert flushing flows away from the RAS in regular intervals and replace water with clean makeup water and adjust the frequency of cleaning and backwashing of biofilters and denitrification units so as to prevent off-flavoring build up.

By way of yet another non-limiting example, another method by which a user may also ensure that the targeted the target sources will not produce off-flavorings again, may be to improve the nitrification rate to reduce ammonium levels which appear to correlate with a high off-flavoring producing quality.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method of preserving optimal flavoring in fish bred within an aquaculture system, comprising:
taking at least one sample of water from at least one portion of the aquaculture system that contains the fish;
testing the at least one sample of water to determine at least one concentration of at least one off-flavor compound therein;
comparing the concentration of said off-flavor compound to an optimal concentration range;
regulating the water in the aquaculture system to maintain a concentration of said off-flavor compound in the water within said optimal concentration range; and
maintaining the fish within the regulated water for at least a predetermined period of time so as to reduce an amount of off-flavor that may be present in the fish.

2. The method of claim 1, wherein the aquaculture system is a recirculating aquaculture system.

3. The method of claim 1, wherein the aquaculture system includes a plurality of tanks, said step of regulating the water in the aquaculture system further comprising regulating the water within at least one tank of the aquaculture system, and maintaining the fish with said tank for said predetermined period of time.

4. The method of claim 1, wherein the at least one portion of the aquaculture system having the at least one sample of water taken therefrom is an interworking of the aquaculture system.

5. The method of claim 1 wherein said step of taking at least one sample of water from at least one portion of the aquaculture system, further comprises taking a plurality of samples of water from different tanks of the aquaculture system, and comparing said samples from all of the tanks so as to identify variations of concentrations in said tanks.

6. The method as recited in claim 1, wherein the at least one off-flavor compound comprises at least one of, Geosmin and 2-Methylisoborneol.

7. The method as recited in claim 6, wherein the optimal concentration range comprises less than 5 micrograms of Geosmin per liter of water and less than 15 micrograms of 2-Methylisoborneol per liter of water.

8. The method of claim 1, wherein said step of the testing the sample of water further comprises using stir bar sorptive extraction so as to test the water and identify at least one concentration of said off-flavor compound.

9. The method of claim 1, wherein said step of the testing the sample of water further comprises using gas chromatography-mass spectrometry so as to test the water and identify at least one concentration of said off-flavor compound.

10. The method of claim 1, wherein said step of maintaining the fish within the regulated water for a predetermined period of time further comprises the steps of:
periodically sampling a fish from within the regulated water, determining concentrations of said off-flavor compound in the sampled fish; and maintaining the fish with the regulated water until the sampled fish has concentrations of said off-flavor compound below less than 200 nanograms of Geosmin per kilogram of fish tissue and less than 15 nanograms of 2-Methylisoborneol per liter of water.

11. The method as recited in claim 1, wherein said predetermined period of time during which said fish is maintained within the regulated water comprises a period of at least 1 week.

12. The method as recited in claim 1, further comprising taking a sample of water from a plurality of different portions of the aquaculture system that contain fish at varying stages of development.

13. The method as recited in claim 1, wherein said step of maintaining the fish within the regulated water further comprises regulating the water in an alternate location of the aquaculture system and maintaining the fish within said alternate location for said predetermined period of time.

14. The method as recited in claim 13, wherein the alternate location of the aquaculture system is a safe limit location of the aquaculture system.

15. The method as recited in claim 14, wherein the safe limit location is a location determined to have a safe level of a concentration of at least one compound so as to not affect a flavor profile associated with the aquaculture.

16. The method as recited in claim 1, further comprising the step of identifying off-flavor compound producing sources and targeting said sources for remedying.

17. The method as recited in claim 16, further comprising remedying the targeted sources so as to prevent the targeted sources from producing at least one off-flavor.

18. A method of preserving optimal flavoring in fish bred within an aquaculture system, comprising:
taking at least one sample of water from at least one portion of the aquaculture system that contains the fish,
testing the at least one sample of water to determine at least one concentration of at least one off-flavor compound therein, and
regulating the contents of aquaculture system accordingly upon determining a concentration of the at least one sample of water.

19. The method of claim 18, wherein the aquaculture system is a recirculating aquaculture system.

20. The method of claim 18, wherein the at least one portion of the aquaculture system having the at least one sample of water taken therefrom is an interworking of the aquaculture system.

21. The method of claim 18, wherein said step of taking at least one sample of water from the at least one portion of the aquaculture system further comprises taking a plurality of samples of water from different portions of the aquaculture system, testing said samples and comparing said samples from all of the portions so as to identify portions of the aquaculture system with different concentrations of at least one off-flavor.

22. The method of claim 21, further comprising identifying portions of the aquaculture system that comprise at least one safe limit location of the aquaculture system.

23. The method of claim 18, wherein the at least one compound comprises at least one of, Geosmin and 2-Methylisoborneol.

24. The method as recited in claim 18, wherein regulating the contents of the aquaculture system further comprises designating the fish within the aquaculture system to a safe limit location of the aquaculture system.

25. The method as recited in claim 24, further comprising identifying off-flavor compound producing sources and targeting said sources for remedying.

26. The method as recited in claim 25, further comprising remedying the targeted sources so as to prevent the targeted sources from producing at least one off-flavor.

27. The method as recited in claim 18, wherein regulating the contents of the aquaculture system further comprises transferring the fish within the aquaculture system to a holding tank for a predetermined period of time so as to apply a process of depuration to the fish.

28. The method as recited in claim 27, further comprises the steps of: periodically sampling fish from the holding tank, determining concentrations of said off-flavor compound in the sampled fish; and maintaining the fish within the tank until the sampled fish have a desired flavoring.

29. The method as recited in claim 27, further comprising identifying off-flavor compound producing sources and targeting said sources for remedying.

30. The method as recited in claim 29, further comprising remedying the targeted sources so as to prevent the targeted sources from producing at least one off-flavor.
